(19) United States
(12) Patent Application Publication
(10) Pub. No.: US 2023/0281477 A1
(43) Pub. Date: Sep. 7, 2023

(54) FRAMEWORK SYSTEM FOR IMPROVING PERFORMANCE OF KNOWLEDGE GRAPH EMBEDDING MODEL AND METHOD FOR LEARNING THEREOF

(71) Applicant: Electronics and Telecommunications Research Institute, Daejeon (KR)

(72) Inventors: Chun-Hee LEE, Daejeon (KR); Dong-oh KANG, Daejeon (KR); Hwa Jeon SONG, Daejeon (KR)

(73) Assignee: Electronics and Telecommunications Research Institute, Daejeon (KR)

(21) Appl. No.: 18/103,962

(22) Filed: Jan. 31, 2023

(30) Foreign Application Priority Data
Mar. 7, 2022 (KR) 10-2022-0028799

(51) Int. Cl. G06N 5/022; G06N 5/02

(52) U.S. Cl. CPC G06N 5/022; G06N 5/027

(57) ABSTRACT

A learning method for improving performance of a knowledge graph embedding model is provided. The method includes: performing learning of a first knowledge graph embedding model based on input knowledge data; extracting all embedding vectors from the learned first knowledge graph embedding model, and extracting prior knowledge based on the extracted embedding vectors; and performing learning of a second knowledge graph embedding model through at least one of initialization of the embedding vectors and transform of the input knowledge data based on the extracted prior knowledge.

### CROSS-REFERENCE TO RELATED APPLICATION

This application claims priority to and the benefit of Korean Patent Application No. 10-2022-0028799, filed on Mar. 7, 2022, the disclosure of which is incorporated herein by reference in its entirety.

### BACKGROUND

### 1. Technical Field

The present disclosure relates to a framework system for improving performance of a knowledge graph embedding model and a method for learning thereof.

### 2. Related Art

Expression of a knowledge graph is the most effective method for a computer device to utilize human knowledge. However, due to scarcity of the knowledge graph, there is a limit in using the knowledge graph on an actual application program. As schemes for overcoming such scarcity, researches for technology to complete the knowledge graph are ongoing.

Among them, the most promising method for completing a knowledge graph is to embed the graph on a low-dimensional continuous vector space. This method learns a vector expression of the knowledge graph, and measures probability or correlation of a specific knowledge (entity) in the graph through an algebraic operation of the vector space. That is, a relation to the entity is expressed by the vector, and the relation is treated as an operator that translates the entity to another location of an embedding space. Accordingly, by finding an instance having a high probability, it is possible to find a new knowledge from the vector space.

The knowledge graph embedding technology in the related art proposes various methods for improving the performance of an embedding model. However, the technology in the related art has problems in that the performance improvement technology is limitedly applied only to a specific knowledge graph embedding model, and also is very difficult to implement.

### SUMMARY

In order to solve the above problems, the present disclosure provides a framework system for improving performance of a knowledge graph embedding model and a method for learning thereof, which can improve the embedding performance of various knowledge graph embedding models.

However, problems to be solved by the present disclosure are not limited to the above-described problems, and other problems may exist.

In a first aspect of the present disclosure to solve the above problems, a learning method for improving performance of a knowledge graph embedding model includes: performing learning of a first knowledge graph embedding model based on input knowledge data; extracting all embedding vectors from the learned first knowledge graph embedding model, and extracting prior knowledge based on the extracted embedding vectors; and performing learning of a second knowledge graph embedding model through at least one of initialization of the embedding vectors and transform of the input knowledge data based on the extracted prior knowledge.

Further, in a second aspect of the present disclosure, a framework system for improving performance of a knowledge graph embedding model includes: a basic learning unit configured to perform learning of a first knowledge graph embedding model; a prior knowledge extraction unit configured to extract prior knowledge based on embedding vectors extracted from the first knowledge graph embedding model; and an enhanced learning unit configured to perform learning of a second knowledge graph embedding model through at least one of initialization of the embedding vectors and transform of input knowledge data for learning based on the prior knowledge.

Further, in a third aspect of the present disclosure, a framework system for improving performance of a knowledge graph embedding model includes: an input module configured to receive input knowledge data; a memory configured to store therein a program for providing a framework for improving performance of the same or different kinds of knowledge graph embedding models based on the input knowledge data; and a processor configured to: perform learning of a first knowledge graph embedding model based on the input knowledge data, extract embedding vectors from the first knowledge graph embedding model and extract prior knowledge based on the extracted embedding vectors, and perform learning of a second knowledge graph embedding model through at least one of initialization of the embedding vectors and transform of the input knowledge data for learning based on the prior knowledge.

In another aspect of the present disclosure to solve the above problems, a computer program executes a learning method for improving the performance of a knowledge graph embedding model in combination with a hardware computer, and is stored in a computer-readable recording medium.

Other detailed matters of the present disclosure are included in the detailed description and drawings.

According to an embodiment of the present disclosure described above, unlike the method for improving the performance of a knowledge graph embedding model in the related art, it is possible to improve the performance of a certain knowledge graph embedding model without code correction.

Further, by using an embodiment of the present disclosure, it is possible to improve the performance of embedding while maintaining the inherent properties of the existing knowledge graph embedding model as it is.

Effects of the present disclosure are not limited to those described above, and other unmentioned effects will be able to be clearly understood by those of ordinary skill in the art from the following description.

### BRIEF DESCRIPTION OF THE DRAWINGS

FIG. 1 is a block diagram of a framework system for improving the performance of a knowledge graph embedding model according to an embodiment of the present disclosure.

FIG. 2 is a diagram explaining operation contents of the framework system for improving the performance of a knowledge graph embedding model according to an embodiment of the present disclosure.

FIG. 3 is a diagram explaining a process of initializing embedding vectors through prior knowledge.

FIG. 4 is a diagram illustrating an algorithm for initializing embedding vectors through prior knowledge.

FIG. 5 is a diagram illustrating a mathematical expression for initializing embedding vectors through transform of an input knowledge graph.

FIG. 6 is a diagram explaining the contents in which a search range of a parameter for clustering is adjusted.

FIG. 7 is a diagram illustrating an algorithm for adjusting a search range of a parameter for clustering in FIG. 6.

FIG. 8 is a flowchart of a learning method for improving the performance of a knowledge graph embedding model according to an embodiment of the present disclosure.

FIG. 9 is a diagram explaining a first embodiment using the same embedding model.

FIG. 10 is a diagram explaining a second embodiment using a different embedding model.

### DETAILED DESCRIPTION

The advantages and features of the present disclosure and methods for achieving the advantages and features will be apparent by referring to embodiments to be described in detail with reference to the accompanying drawings. However, the present disclosure is not limited to the embodiments disclosed below, and it can be implemented in various different forms. However, the embodiments are provided to complete the present disclosure and to assist those of ordinary skill in the art in a comprehensive understanding of the scope of the present disclosure, and the present disclosure is only defined by the scope of the appended claims.

Terms used in the description are to explain the embodiments, but are not intended to limit the present disclosure. In the description, unless specially described on the context, a singular form includes a plural form. In the description, the term “comprises” and/or “comprising” should be interpreted as not excluding the presence or addition of one or more other constituent elements in addition to the mentioned constituent elements. Throughout the whole description, the same reference numerals are used to indicate the same constituent elements, and the term “and/or” includes each of the mentioned constituent elements and all combinations of one or more thereof. The terms “first”, “second”, and so forth are used to describe various constituent elements, but these constituent elements should not be limited by the terms. The above-described terms are used only for the purpose of discriminating one constituent element from another constituent element. Accordingly, the first constituent element to be mentioned hereinafter may be the second constituent element in the technical idea of the present disclosure.

Unless otherwise defined, all terms (including technical and scientific terms) used in the description may be used as the meaning that can be commonly understood by those skilled in the art to which the present disclosure pertains. Further, unless clearly and specially defined, the terms defined in generally used dictionaries should not be interpreted ideally or excessively.

Hereinafter, to help understanding of those skilled in the art, backgrounds in which the present disclosure is conceived will be first described, and then, the present disclosure will be described in detail.

Recently, with the development of a collaborative platform, such as Internet and Wikipedia, establishment of a large-capacity knowledge graph becomes possible. A representative large-capacity knowledge graph may be YAGO. The YAGO has been established based on the Wikipedia and Wordnet.

In spite of the establishment of such a large-capacity knowledge graph, there are still many missing links. As a technology to complement the missing links, there is a graph completion technology. Among various kinds of graph completion technologies, a recent spotlighted technology is a method using graph embedding. The graph embedding technology may be utilized in various fields, such as entity linking, in addition to the graph completion.

Up to now, many kinds of knowledge graph embedding methods have been proposed, and as representative methodologies, there are translation based approach and bilinear approach.

Representative examples of knowledge graph embedding methods using the translation based approach in the related art include TransE (Bordes et al., 2013), TransH (Wang et al., 2014), TransR (Lin et al., 2015), and TransD (Ji et al., 2015).

As an example, the TransE technique is a method for searching for vector expressions of head (h), tail (t), and relation (r) by forcing a vector of t so as to make the vector sum of h and r equal to the vector of t (h+r=t) when a knowledge triple (h, r, and t) composed of a relation (r) and two entities (h and t) is given. For this, the TransE uses a score function as in the following Equation 1.

$$L = {\sum }_{\left(h , r , t\right) ∈ S} {\sum }_{\left({h}^{′} , r , {t}^{′}\right) ∈ {S}^{′}} {\left[λ + d \left(h + r , t\right) - d \left({h}^{′} + r , {t}^{′}\right)\right]}_{+} \qquad \text{[Equation 1]}$$

In Equation 1, S represents a positive sample set, S′ represents a negative sample set, and d is a distance function that uses L₁ or L₂ norm. Further, λ represents a hyperparameter margin, and [x]+ is max(0,x).

As a representative methodology of the bilinear approach in the related art, there is a DistMult technique. The DistMult uses a score function as in the following Equation 2.

$$< h , r , t > = \sum {h}_{i} {r}_{i} {t}_{i} \qquad \text{[Equation 2]}$$

Recently, rather than developing a new knowledge graph embedding model, many methods for improving the performance of the existing knowledge graph embedding models have been developed. For example, there is a method that uses an ensemble technique.

The knowledge graph embedding ensemble technique is an embedding technology having a better performance by combining various kinds of knowledge graph embedding models, and in this case, the ensemble is one of technologies that are widely utilized in the machine learning field.

However, in case of the knowledge graph embedding, unlike the ensemble in the existing machine learning, the embedding results are not simply merged. For this, in the related art (Krompass, D.; and Tresp, V. 2015, Ensemble Solutions for Link-Prediction in Knowledge Graphs, In 2nd Workshop on Linked Data for Knowledge Discovery), the results of respective models are combined by transforming a score into a probability.

However, transforming the score into the probability is not simple, and may break the inherent properties of the existing knowledge graph embedding model during combination of the respective models. For example, in case of a certain embedding model, if the ensemble is used in making the embedding so as to learn the properties, such as a transitive relation, the above-described properties may be broken.

As another method, there is a method for giving constraints. In the corresponding related art (Boyang Ding, Quan Wang, Bin Wang and Li Guo, Improving Knowledge Graph Embedding Using Simple Constraints, Proceedings of the 56th Annual Meeting of the Association for Computational Linguistics (ACL) 2018, pp. 110-121.), the existing knowledge graph embedding has been improved by using a non-negativity constraint and an approximate entailment constraint. The first case helps learning of an entity compact / interpretable representation, and the second case helps encoding of regularity of logical entailment between relations.

In case of the non-negativity constraint, a non-negativity condition in the form as in the following Equation 3 is made as the constraint. Intuition for this is to use a positive property rather than a negative property when people are generally described as entities.

$$0 \leq Re \left(\text{e}\right) , \text{Im} \left(\text{e}\right) \leq 1 , ∀ e ∈ \text{ε} \qquad \text{[Equation 3]}$$

In this case, in Equation 3, e ∈ ℂ^{d} is a vector expression of an entity e ∈ ε, and is a constituent element of a real number and an imaginary number being represented as Re(e), Im(e) ∈ ℝ^{d}. Further, 0 and 1 are d-dimensional vectors of which all items are 0 or 1, and ≤, ≥, = represent comparison operators for each item.

Second, in case of the approximate entailment constraint, the following Equation 4 is used as the constraint expressing an inclusion relation between entities.

$$∅ \left({e}_{i} , {r}_{p} , {e}_{j}\right) \leq ∅ \left({e}_{i} , {r}_{q} , {e}_{j}\right) , ∀ {e}_{i} , {e}_{j} ∈ \text{ε} \qquad \text{[Equation 4]}$$

In this case, in Equation 4, Ø(·,·,· ) represents a score for a triple predicted by an embedding model.

However, it is not simple to actually implement the above method. Further, since it is required to correct each model to a code level, it is not easy to apply the method to a certain embedding model.

In order to solve the above problems, an embodiment of the present disclosure proposes a framework that can improve a certain knowledge graph embedding model more easily. That is, the framework has been designed to improve the existing embedding model in consideration of only an input and an output of the existing knowledge graph embedding model.

Accordingly, since an embodiment of the present disclosure can be applied to a certain knowledge graph embedding model, can be easily implemented, and can use the existing embedding model as it is, it is possible to prevent the problem in that the properties of the embedding model are broken.

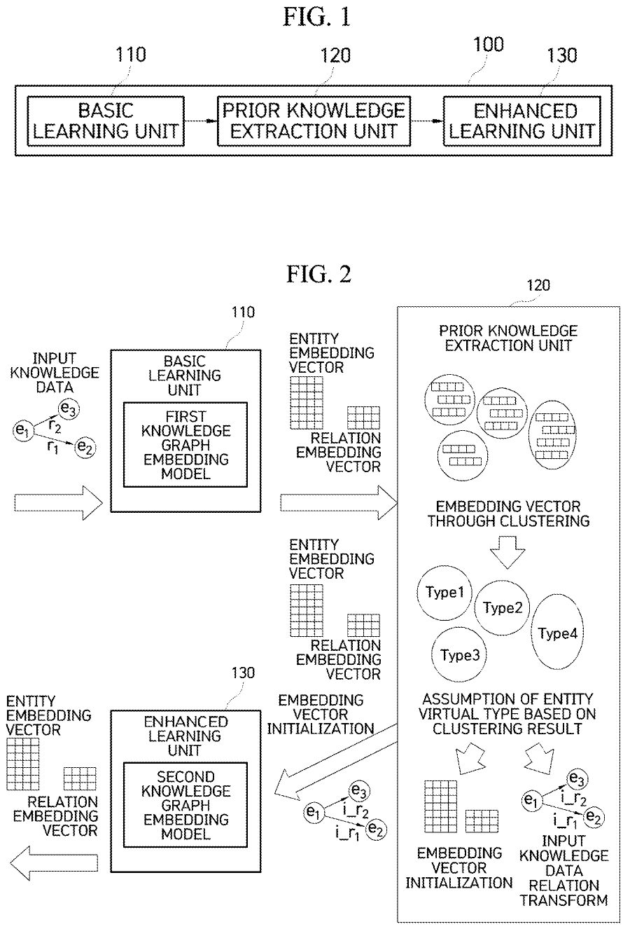

Hereinafter, a framework system for improving the performance of a knowledge graph embedding model according to an embodiment of the present disclosure will be described with reference to FIGS. 1 to 7.

FIG. 1 is a block diagram of a framework system for improving the performance of a knowledge graph embedding model according to an embodiment of the present disclosure. FIG. 2 is a diagram explaining operation contents of the framework system for improving the performance of a knowledge graph embedding model according to an embodiment of the present disclosure.

An embodiment of the present disclosure is a knowledge graph embedding related technology, and is featured by providing a framework that can apply the existing knowledge graph embedding model rather than developing a new knowledge graph embedding model and can improve the performance of the existing knowledge graph embedding model.

According to an embodiment of the present disclosure, the existing model can be used as it is without any code correction thereof (according to circumstances, to the extent of adding some interfaces, and thus the model performance can be easily improved. Further, since the result of the enhanced learning process is used as the final embedding vector, the inherent properties (e.g., symmetry, anti-symmetry, inversion, hierarchy, etc.) of the embedding model used in the enhanced learning process can be maintained as they are.

The framework system according to an embodiment of the present disclosure includes a basic learning unit, a prior knowledge extraction unit, and an enhanced learning unit. In this case, the framework system may be composed of an input module configured to receive input knowledge data, a memory configured to store therein a program for providing a framework for improving performance of the same or different knowledge graph embedding models based on the input knowledge data, and a processor configured to execute the program stored in the memory.

First, the basic learning unit performs learning of a first knowledge graph embedding model based on the input knowledge data.

The input knowledge data (knowledge graph) means a relation between a plurality of entities expressed by a map. Further, the entity is a unit of meaningful information, and for example, in case of a file processing system, a record or information constituting one piece of data corresponds to one entity. The relationship between entities is referred to as a relation, and it may be defined as an input knowledge graph in which the relation between a plurality of entities is expressed by a map.

A learning process by the basic learning unit is performed in the same manner as the existing knowledge graph embedding learning. However, according to an embodiment of the present disclosure, unlike the existing embedding model, the learning is performed by the basic learning unit in order to extract prior knowledge.

Meanwhile, various kinds of prior knowledge may be applied to an embodiment of the present disclosure, but in the following description, it is described that a type is utilized as the prior knowledge. However, the kind of prior knowledge is not necessarily limited thereto.

Next, the prior knowledge extraction unit extracts all embedding vectors from the learned first knowledge graph embedding model, and extracts the prior knowledge based on the extracted embedding vectors.

In this case, in an embodiment of the present disclosure, it is assumed that the same types of entities have similar embedding vectors in order to extract the type as the prior knowledge.

Based on such assumption, the prior knowledge extraction unit extracts and clusters entity embedding vectors from the previously learned first knowledge graph embedding model. As an example, in the present disclosure, k entity embedding vectors may be clustered by applying k-means clustering. However, the clustering method in an embodiment of the present disclosure is not limited thereto, and of course, various kinds of clustering methods can be applied.

The prior knowledge extraction unit may determine a virtual type of an entity to be utilized as a prior knowledge based on the result of clustering as in the following Equation 5.

$$t y p e \left({e}_{i}\right) = ″ \text{guessed\_type\_″ +} c l u s t e r \_ n u m b e r \left({e}_{i}\right) \qquad \text{[Equation 5]}$$

Meanwhile, the prior knowledge extraction unit may extract not only an entity embedding vector but also a relation embedding vector from the learned first knowledge graph embedding model, and may perform the clustering in consideration of both the entity embedding vector and the relation embedding vector.

Next, the enhanced learning unit performs learning of a second knowledge graph embedding model by applying at least one of initialization of the embedding vector and transform of input knowledge data based on the extracted prior knowledge. That is, after the extraction of the prior knowledge, the enhanced learning unit performs the enhanced learning by using the two methods.

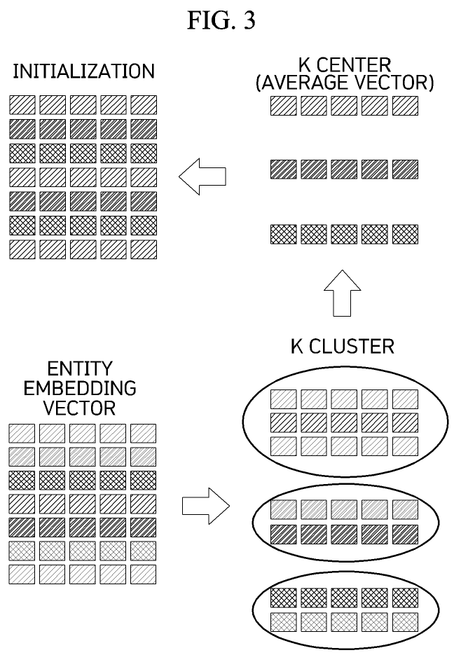

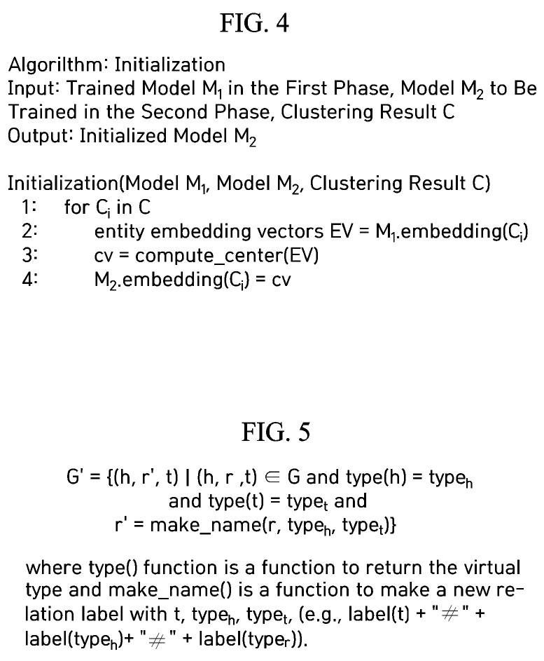

FIG. 3 is a diagram explaining a process of initializing embedding vectors through a prior knowledge. FIG. 4 is a diagram illustrating an algorithm for initializing embedding vectors through a prior knowledge.

In case of the existing embedding model, a simple initialization method, such as Uniform, has been used. However, in the present disclosure, the previously extracted prior knowledge is reflected in the embedding initialization.

The enhanced learning unit calculates an average vector (Center) of embedding vectors that belong to the same type of cluster for each cluster generated as the result of clustering. Then, the enhanced learning unit determines the calculated average vector as an embedding vector initialization value of the entity belonging to the same type of cluster.

Thereafter, the enhanced learning unit performs the learning of the second knowledge graph embedding model based on the embedding vector initialization value and the input knowledge data. In this case, in an embodiment of the present disclosure, virtual type information is reflected in the initialized embedding vector, and thus the performance of the existing knowledge graph embedding model can be improved.

Next, the contents in which the second knowledge graph embedding model is deeply learned through the transform of the input knowledge data will be described.

FIG. 5 is a diagram illustrating a mathematical expression for initializing embedding vectors through transform of an input knowledge graph.

The second method using the prior knowledge is to transform an input knowledge graph. Even in case of the same relation, it may have a different meaning depending on the type of an entity. For example, a related relation connected to a car (entity) and a related relation connected to a person (entity) may have the same relation name, but have different meanings. In this case, a more accurate embedding learning becomes possible by configuring the term “related” that is connected to the car to car-related, and configuring the term “related” that is connected to the person to person-related. However, since all knowledge graphs do not have the entity types, in the present disclosure, the virtual type obtained in the prior knowledge extraction process may be utilized.

For this, the enhanced learning unit may transform the relation of the input knowledge data based on the virtual type of the entity determined by the prior knowledge extraction unit, and may perform the learning of the second knowledge graph embedding model based on the input knowledge data of which the relation has been transformed.

Specifically, the enhanced learning unit may transform the input knowledge data by using the following Equation 6.

$$\begin{matrix}{G}^{′} = \left\{\left(\left(h , {r}^{′} , t\right)\right| \left(h , r , t\right) ∈ G a n d t y p e \left(h\right) = t y p {e}_{h}\right) \\ a n d t y p e \left(t\right) = t y p {e}_{t} a n d \\ \left({r}^{′} = m a k e \_ n a m e \left(r , t y p {e}_{h} , t y p {e}_{t}\right)\right\}\end{matrix} \qquad \text{[Equation 6]}$$

In Equation 6 above, the function type() is a function for returning the virtual type, and the function make_name() is a function for forming new relation labels as t, typeₕ, and typeₜ (e.g., label(t)+”#”+label(typeₕ₎+”#”+ label(typeᵣ).

The enhanced learning unit performs the learning of the second knowledge embedding model based on the input knowledge data transformed according to Equation 6. In this case, the transformed knowledge graph data includes more detailed information than the existing input knowledge graph data through additional reflection of the virtual type information, and thus the existing embedding performance can be improved.

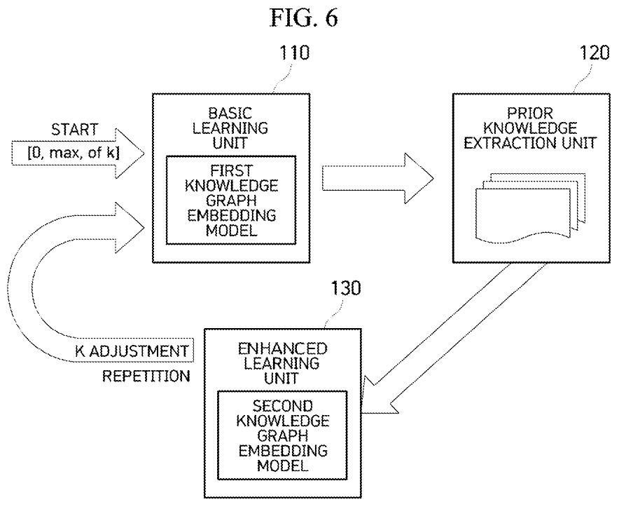

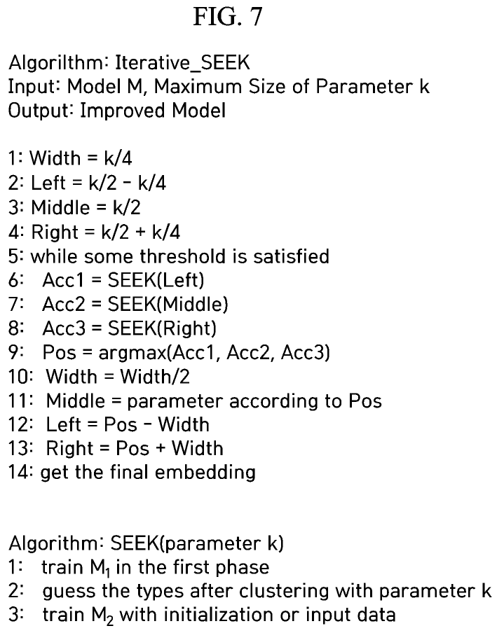

FIG. 6 is a diagram explaining the contents in which a search range of a parameter for clustering is adjusted. FIG. 7 is a diagram illustrating an algorithm for adjusting a search range of a parameter for clustering of FIG. 6.

Meanwhile, in an embodiment of the present disclosure, a search range k of a predetermined parameter may be adjusted for clustering. An optimum k value may differ depending on the property of input data, and it is difficult for a user to set the optimum k value every time. In order to solve this problem, an embodiment of the present disclosure is featured to perform an iterative process as in FIG. 6.

That is, in an embodiment of the present disclosure, if the range of the k value to be searched for is first given, the search range of the predetermined parameter for the clustering is adjusted through the iterative process with the completion of the learning of the second knowledge graph embedding model. For example, the optimum k value is calculated while reducing the range of the k value through the iterative process. Thereafter, the prior knowledge extraction unit re-performs the clustering based on the parameter of which the k value has been adjusted.

Meanwhile, in the framework system according to an embodiment of the present disclosure, the first knowledge graph embedding model that is the target of the basic learning and the second knowledge graph embedding model that is the target of the enhanced learning may apply the same knowledge graph embedding models. For example, the first and second knowledge graph embedding models may be the same TransE embedding models.

Unlike this, in the framework system according to an embodiment of the present disclosure, the first knowledge graph embedding model that is the target of the basic learning and the second knowledge graph embedding model that is the target of the enhanced learning may be different knowledge graph embedding models. For example, the first knowledge graph embedding model may be a TransE embedding model, and the second knowledge graph embedding model may be a BoxE embedding model. In case of the present embodiment, since the final embedding intended to be used is the second knowledge graph embedding model, various inherent properties (symmetry, anti-symmetry, inversion, and hierarchy) of the BoxE can be maintained as they are. Further, the performance of the final embedding model can be improved by disposing an embedding model having good performance as the first knowledge graph embedding model.

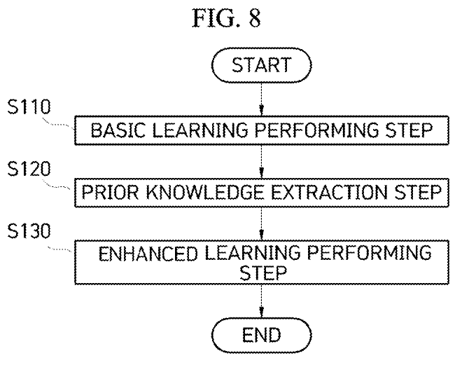

Hereinafter, a learning method that is performed by the framework system for improving the performance of a knowledge graph embedding model according to an embodiment of the present disclosure will be described with reference to FIGS. 8 to 10.

FIG. 8 is a flowchart of a learning method for improving the performance of a knowledge graph embedding model according to an embodiment of the present disclosure.

In an embodiment of the present disclosure, a basic learning step of performing learning of the first knowledge graph embedding model is first performed based on input knowledge data (S110).

Next, a prior knowledge extraction step of extracting all embedding vectors from the learned first knowledge graph embedding model and extracting a prior knowledge based on the extracted embedding vectors is performed (S120).

Next, an enhanced learning step of performing learning of a second knowledge graph embedding model through at least one of initialization of the embedding vectors and transform of the input knowledge data based on the extracted prior knowledge is performed (S130).

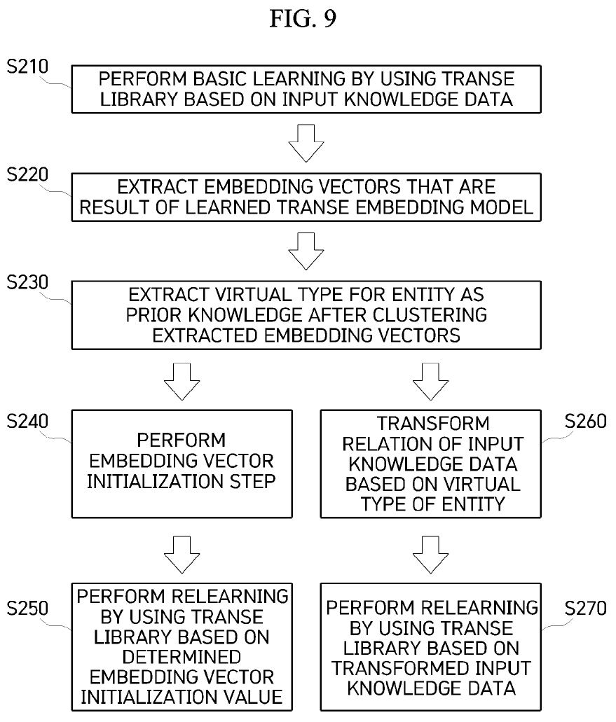

FIG. 9 is a diagram explaining a first embodiment using the same embedding models.

FIG. 9 illustrates a case where a first knowledge graph embedding model that is the target of basic learning and a second knowledge graph embedding model that is the target of enhanced learning are the same knowledge graph embedding models, and the first and second knowledge graph embedding models may be the same TransE embedding models.

First, the basic learning is performed by using a TransE library based on input knowledge data (S210).

Next, embedding vectors, which are the result of the learned TransE embedding model, are extracted (S220), and after the extracted embedding vectors are clustered, a virtual type for each entity is extracted as a prior knowledge (S230). In this case, k-means clustering may be applied as a clustering method.

Next, for each cluster generated as the result of the clustering, an average vector of the embedding vectors belonging to the same type of cluster is calculated, and an embedding vector initialization step of determining the calculated average vector as an embedding vector initialization value of the entity belonging to the same type of cluster is performed (S240).

Then, the learning is performed once again by using the TransE library based on the determined embedding vector initialization value (S250).

As another embodiment, a relation of the input knowledge data is transformed based on the virtual type of the entity determined in the prior knowledge extraction step (S260), and the learning is performed once again by using the TransE library based on the transformed input knowledge data (S270).

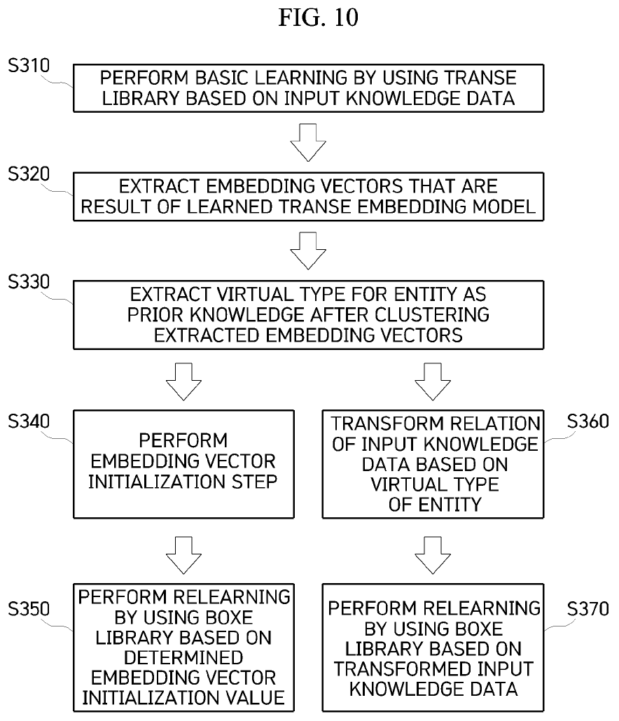

FIG. 10 is a diagram explaining a second embodiment using different embedding models.

FIG. 10 illustrates a case where a first knowledge graph embedding model that is the target of basic learning and a second knowledge graph embedding model that is the target of enhanced learning are different knowledge graph embedding models, and the first knowledge graph embedding model may be a TransE embedding model and the second knowledge graph embedding model may be a BoxE embedding model.

First, the basic learning is performed by using a TransE library based on input knowledge data (S310).

Next, embedding vectors, which are the result of the learned TransE embedding model, are extracted (S320), and after the extracted embedding vectors are clustered, a virtual type for each entity is extracted as a prior knowledge (S330). In this case, k-means clustering may be applied as a clustering method.

Next, for each cluster generated as the result of the clustering, an average vector of the embedding vectors belonging to the same type of cluster is calculated, and a TransE embedding vector initialization step of determining the calculated average vector as an embedding vector initialization value of the entity belonging to the same type of cluster is performed (S340).

Then, the learning is performed once again by using the BoxE library based on the determined embedding vector initialization value (S350).

As another embodiment, a relation of the input knowledge data is transformed based on the virtual type of the entity determined in the prior knowledge extraction step (S360), and the learning is performed once again by using the TransE library based on the transformed input knowledge data (S370).

Meanwhile, in the above explanation, steps S110 to S370 may be further divided into additional steps or may be combined into fewer steps in accordance with the implementation examples of the present disclosure. Further, if necessary, some steps may be omitted, or the order of the steps may be changed. In addition, even other omitted contents of FIGS. 1 to 7 may also be applied to the method of FIGS. 8 to 10.

An embodiment of the present disclosure described above may be implemented as a program (or application) to be executed in combination with a hardware computer, and may be stored in a medium.

In order for the computer to read the above-described program so as to execute the above methods implemented as the program, the program may include a code coded by a computer language, such as Python, C, C++, JAVA, Ruby, and machine language, which can be read by a processor (CPU) of the computer through a device interface of the computer. Such a code may include a functional code related to a function that defines functions necessary to execute the above methods, and may include a control code related to an execution procedure necessary for the processor of the computer to execute the above functions according to a specific procedure. Further, such a code may further include a memory reference related code regarding at which location (address) of an internal or external memory of the computer additional information or media necessary for the processor of the computer to execute the above functions is to be referred to. Further, in case that the processor of the computer is required to communicate with any other remote computer or server to execute the above functions, the code may further include a communication related code regarding how to communicate with any other remote computer or server by using a communication module of the computer, or which information or medium is to be transmitted/received during the communication.

The storage medium means a medium which semi-permanently stores data and which can be read by a device, rather than a medium which stores data for a short time, such as a register, cache, or memory. Specific examples of the storage medium include ROM, RAM, CD-ROM, magnetic tape, floppy disc, and optical data storage device, but are not limited thereto. That is, the program may be stored in various recording media on various servers that can be accessed by the computer, or various recording medium on a user’s computer. Further, the medium may be distributed in a computer system connected through a network, and may store a code that can be read by the computer in a distributed manner.

The above explanation of the present disclosure is for illustrative purposes, and it can be understood by those of ordinary skill in the art to which the present disclosure pertains that the present disclosure can be easily modified in other specific forms without changing the technical idea or essential features of the present disclosure. Accordingly, it should be understood that the above-described embodiments are illustrative in all aspects, not restrictive. For example, each constituent element explained as a single type may be distributed and carried out, and in the same manner, constituent elements explained as being distributed may be carried out in a combined form.

The scope of the present disclosure is defined by the appended claims to be described later rather than the above-described detailed description, and all changes or modifications derived from the meanings, scope, and equivalent concept of the claims should be interpreted as being included in the scope of the present disclosure.

What is claimed is:

1. A learning method for improving performance of a knowledge graph embedding model in a method performed by a computer, the learning method comprising:
performing learning of a first knowledge graph embedding model based on input knowledge data;
extracting all embedding vectors from the learned first knowledge graph embedding model, and extracting prior knowledge based on the extracted embedding vectors; and
performing learning of a second knowledge graph embedding model through at least one of initialization of the embedding vectors and transform of the input knowledge data based on the extracted prior knowledge.

2. The learning method of claim 1, wherein the extracting of the prior knowledge comprises:
extracting and clustering entity embedding vectors from the learned first knowledge graph embedding model; and
determining a virtual type of an entity to be utilized as the prior knowledge based on the result of clustering.

3. The learning method of claim 2, further comprising readjusting a search range of a predetermined parameter for clustering as the learning of the second knowledge graph embedding model is completed,
wherein the extracting and clustering of the entity embedding vectors from the learned first knowledge graph embedding model performs the clustering based on the adjusted parameter.

4. The learning method of claim 2, wherein the extracting of the prior knowledge further comprises extracting relation embedding vectors from the learned first knowledge graph embedding model, and
wherein the extracting and clustering of the entity embedding vectors from the learned first knowledge graph embedding model performs clustering the extracted entity embedding vectors and relation embedding vectors.

5. The learning method of claim 2, wherein the performing of the learning of the second knowledge graph embedding model comprises:
calculating an average vector of the embedding vectors belonging to the same type of cluster for each cluster generated as the result of the clustering;
determining the calculated average vector as an embedding vector initialization value of the entity belonging to the cluster of the same type; and
performing the learning of the second knowledge graph embedding model based on the determined embedding vector initialization value.

6. The learning method of claim 2, wherein the performing of the learning of the second knowledge graph embedding model comprises:
transforming a relation of the input knowledge data based on the determined virtual type of the entity; and
performing the learning of the second knowledge graph embedding model based on the input knowledge data of which the relation has been transformed.

7. The learning method of claim 1, wherein the first knowledge graph embedding model and the second knowledge graph embedding model are the same kinds of knowledge graph embedding models.

8. The learning method of claim 1, wherein the first knowledge graph embedding model and the second knowledge graph embedding model are different kinds of knowledge graph embedding models.

9. A framework system for improving performance of a knowledge graph embedding model, the framework system comprising:
a basic learning unit configured to perform learning of a first knowledge graph embedding model;
a prior knowledge extraction unit configured to extract prior knowledge based on embedding vectors extracted from the first knowledge graph embedding model; and
an enhanced learning unit configured to perform learning of a second knowledge graph embedding model through at least one of initialization of the embedding vectors and transform of input knowledge data for learning based on the prior knowledge.

10. The framework system of claim 9, wherein the prior knowledge extraction unit is configured to: extract and cluster entity embedding vectors and relation embedding vectors from the learned first knowledge graph embedding model, and determine a virtual type of an entity to be utilized as the prior knowledge based on the result of clustering.

11. The framework system of claim 10, wherein a search range of a predetermined parameter for clustering is adjusted as the learning of the second knowledge graph embedding model is completed, and
wherein the prior knowledge extraction unit is configured to perform the clustering based on the adjusted parameter.

12. The framework system of claim 10, wherein the enhanced learning unit is configured to: calculate an average vector of the embedding vectors belonging to a cluster of the same type for each cluster generated as the result of the clustering, determine the calculated average vector as an embedding vector initialization value of the entity belonging to the cluster of the same type, and then perform the learning of the second knowledge graph embedding model based on the determined embedding vector initialization value.

13. The framework system of claim 10, wherein the enhanced learning unit is configured to: transform a relation of the input knowledge data based on the determined virtual type of the entity, and perform the learning of the second knowledge graph embedding model based on the input knowledge data of which the relation has been transformed.

14. The framework system of claim 9, wherein the first knowledge graph embedding model and the second knowledge graph embedding model are the same kinds of knowledge graph embedding models.

15. The framework system of claim 9, wherein the first knowledge graph embedding model and the second knowledge graph embedding model are different kinds of knowledge graph embedding models.

16. A framework system for improving performance of a knowledge graph embedding model, the framework system comprising:
an input module configured to receive input knowledge data;
a memory configured to store therein a program for providing a framework for improving performance of the same or different kinds of knowledge graph embedding models based on the input knowledge data; and
a processor configured to: perform learning of a first knowledge graph embedding model based on the input knowledge data, extract embedding vectors from the first knowledge graph embedding model and extract prior knowledge based on the embedding vectors, and perform learning of a second knowledge graph embedding model through at least one of initialization of the embedding vectors and transform of the input knowledge data for learning based on the prior knowledge.
